(19) United States
(12) Patent Application Publication
(10) Pub. No.: US 2017/0344107 A1
(43) Pub. Date: Nov. 30, 2017

(54) AUTOMATIC VIEW ADJUSTMENTS FOR COMPUTING DEVICES BASED ON INTERPUPILLARY DISTANCES ASSOCIATED WITH THEIR USERS

(71) Applicant: Intel Corporation, Santa Clara, CA (US)

(72) Inventors: Sanjay R. Aghara, Bangalore (IN); Aditya Kishore Raut, Bangalore (IN)

(73) Assignee: Intel Corporation, Santa Clara, CA (US)

(21) Appl. No.: 15/164,231

(22) Filed: May 25, 2016

(51) Int. Cl. G06F 3/01; G02B 27/01; G06K 9/00

(52) U.S. Cl. CPC G06F 3/013; G06K 9/00604; G02B 27/0172; G02B 2027/0132; G02B 2027/0187

(57) ABSTRACT

A mechanism is described for facilitating automatic view adjustment for computing devices based on interpupillary distance associated with users according to one embodiment. A method of embodiments, as described herein, includes facilitating sensors to detect a user within proximity of the apparatus such that eyes of the user face lenses of a computing device, and measuring a first distance between a first sensor and a second sensor of the sensors. The method further include measuring a second distance between a first pupil of a first eye of the eyes and a second pupil of a second eye of the eyes of the user, and adjusting a first lens or a second lens of the lenses to match the second distance with the first distance.

### FIELD

Embodiments described herein generally relate to computers. More particularly, embodiments relate to facilitating automatic view adjustments for computing devices based on interpupillary distances associated with their users.

### BACKGROUND

Conventional adjustment techniques are limited to offering manual adjustments to distance between lenses and/or displays of a device to compensate for interpupillary distance relating to a user of the device. Such manual adjustments are offered through manual adjustment tools (e.g., knobs, slides) that are cumbersome, time-consuming, and inaccurate as they are prone to human error.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing an automatic view adjustment mechanism according to one embodiment.

FIG. 2 illustrates an automatic view adjustment mechanism according to one embodiment.

FIG. 3A illustrates a computing device including a head-mounted display according to one embodiment.

FIG. 3B illustrates an architectural placement according to one embodiment.

FIG. 3C illustrates an architectural placement according to one embodiment.

FIG. 4 illustrates a method for facilitating dynamic and automatic adjustment of lenses and/or displays of a computing device based on interpupillary distances associated with one or more users according to one embodiment.

FIG. 5 illustrates computer environment suitable for implementing embodiments of the present disclosure according to one embodiment.

FIG. 6 illustrates a method for facilitating dynamic targeting of users and communicating of message according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel technique for facilitating dynamic and automatic adjustment of distance between lenses and/or displays associated with viewing systems or devices (such as head-mounted displays (HMDs), night vision goggles (NVGs), binocular microscopes, wearable glasses, head-mounted binoculars, gaming displays, military headwear, etc.) based on interpupillary distance (IPD) (also referred to as pupillary distance (PD)) of users of the viewing devices.

It is contemplated that embodiments are not limited to any particular type of viewing devices or their particular number or type of lenses and/or displays, such as a viewing device having a single display and multiple lenses, or multiple displays and multiple lenses, etc. Further, it is contemplated that IPD generally refers to the distance between the two centers of the two pupils of the two eyes of a user and is regarded as essential in designing viewing devices so that the two eyes of the user may be positioned or aligned with the exit pupils of the viewing devices.

It is contemplated and to be noted that embodiments are not limited to any particular number and type of powered devices, unpowered objects, software applications, application services, customized settings, etc., or any particular number and type of computing devices, networks, deployment details, etc.; however, for the sake of brevity, clarity, and ease of understanding, throughout this document, references are made to various sensors, cameras, microphones, speakers, display screens, user interfaces, software applications, user preferences, customized settings, mobile computers (e.g., smartphones, tablet computers, etc.), communication medium/network (e.g., cloud network, the Internet, proximity network, Bluetooth, etc.), but that embodiments are not limited as such.

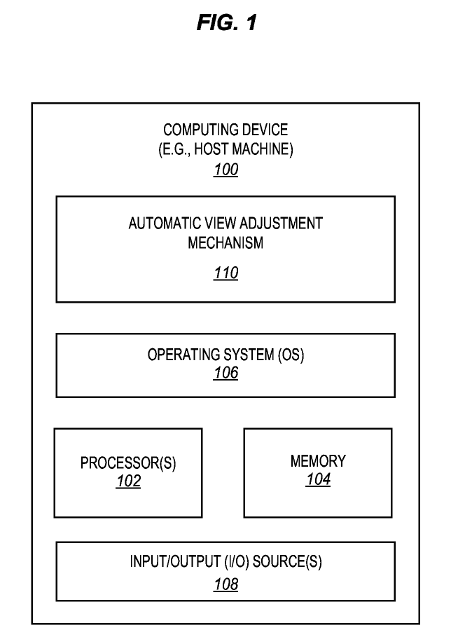

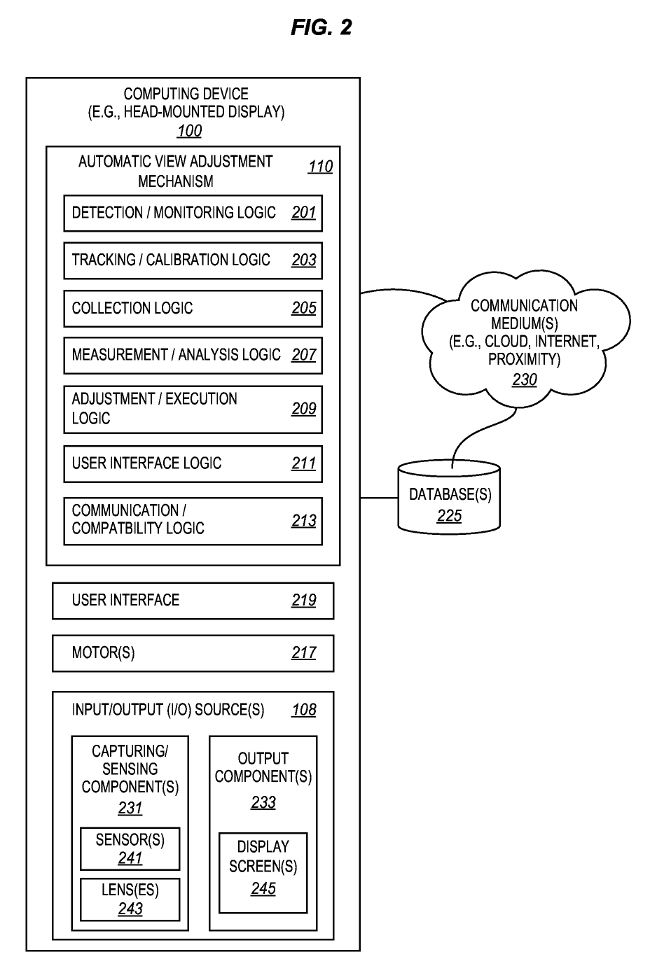

FIG. 1 illustrates a computing device 100 employing an automatic view adjustment mechanism (“adjustment mechanism”) 110 according to one embodiment. Computing device 100 (e.g., viewing device, such as HMDs, NVGs, binocular viewing systems, etc.) serves as a host machine for hosting adjustment mechanism 110 that includes any number and type of components, as illustrated in FIG. 2, to facilitate smart dynamic and automatic adjustment of lenses and/or displays of computing device 100 based on its user's IPD as will be further described throughout this document.

Computing device 100 may include any number and type of viewing systems or devices, such as HMDs, NVGs, binoculars, binocular viewing systems, binocular microscopes, wearable glasses, head-mounted binoculars, gaming displays, military headwear, and/or the like. Although, throughout this document, any discussion relating to adjustment mechanism 110 is primarily based on a specific type of computing devices, such as the aforementioned viewing systems/devices (e.g., HMDs, such as gaming displays, etc.), it is contemplated that embodiments are not limited as such and that any novel techniques offered by adjustment mechanism 110 may be applied to or in association with other types of computing devices (e.g., laptops, smartphones, tablet computers, etc.) and their lenses and/or display screens.

For example, computing device 100 may include any number and type of data processing devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, HMDs (e.g., wearable glasses, head-mounted binoculars, gaming displays, military headwear, etc.), and other wearable devices (e.g., smartwatches, bracelets, smartcards, jewelry, clothing items, etc.), Internet of Things (IoT) devices, and/or the like.

Computing device 100 may include an operating system (OS) 106 serving as an interface between hardware and/or physical resources of the computer device 100 and a user. Computing device 100 further includes one or more processor(s) 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a person or a group of individuals or persons using or having access to one or more computing devices, such as computing device 100.

FIG. 2 illustrates adjustment mechanism 110 of FIG. 1 according to one embodiment. In one embodiment, adjustment mechanism 110 may include any number and type of components, such as (without limitation): detection/monitoring logic 201; tracking/calibration logic 203; collection logic 205; measurement/analysis logic 207; adjustment/execution logic 209; user interface logic 211; and communication/compatibility logic 213. Computing device 100 is further shown to include specific application-based and/or general purpose-based user interface 219 (e.g., graphical user interface (GUI)-based user interface, Web browser, application-based user interface, mobile application-based user interface, etc.) as facilitated by user interface logic 211. Computing device 100 is further shown to host I/O source(s) 108 including capturing/sensing component(s) 231 and/or output component(s) 233. Further, computing device 100 includes one or more motor(s) 217 serving as a movement mechanism for facilitating movement of one or more lenses 243 and/or one or more displays. Computing device 100 is further illustrated as having access to and being in communication with one or more database(s) 225.

Although not illustrated, it is contemplated that computing device 100 (such as a gaming display) may be in communication with one or more of other computing devices (such as other gaming displays) over communication medium(s) 230, such as one or more networks (e.g., a cloud network, a proximity network, the Internet, etc.). Further, in one embodiment, adjustment mechanism 110 may be hosted entirely at and by computing device 100. In another embodiment, one or more components of adjustment mechanism 110 may be hosted at and by another computing device, such as a server computer.

As aforementioned, computing device 100 may host I/O sources 108 including capturing/sensing component(s) 231 and output component(s) 233. In one embodiment, capturing/sensing components 231 may include sensor array (such as microphones or microphone array (e.g., ultrasound microphones), cameras or camera array (e.g., two-dimensional (2D) cameras, 3D cameras, infrared (IR) cameras, depth-sensing cameras, etc.), capacitors, radio components, radar components, etc.), scanners, accelerometers, etc. For example, capturing/sensing components 231 may include one or more eye-tracking sensor(s) 241, one or more lens(es) 243, etc. Similarly, output component(s) 233 may include any number and type of display screens/devices, projectors, speakers, light-emitting diodes (LEDs), one or more speakers and/or vibration motors, etc., such as one or more display screen(s) 245.

As aforementioned, computing device 100 may host or in communication with one or more storage mediums or devices, repositories, data sources, databases, such as database(s) 225, having any amount and type of information, such as data, metadata, etc., relating to any number and type of applications, such as data and/or metadata relating to one or more users, one or more IPDs of the one or more users, user preferences and/or profiles, historical and/or preferred details relating to lens/display adjustments, security and/or authentication data, and/or the like.

As previously described, in virtual reality HMDs, such as computing device 100, IPD of a user is regarded as a key parameter for offering optimum viewing or displaying experience for the user. For example, if the distance between lenses 243 or image displays do not match the user's IPD, the user is likely to see distortion in images being displayed by one or more display screens 245 as offered through user interface 219 as facilitated by user interface logic 211.

As further discussed earlier, conventional techniques are merely limited to manual adjustments through manual devices, such as a knob or a mechanical bar, which is cumbersome, time-consuming, and inaccurate as it is prone to human error.

Embodiments provide for a monitoring and detecting both pupils of the user of computing device 100 using sensors, such as eye-tracking sensor(s) 241, to compute an accurate IPD of the user and then apply this to lenses 243 and/or displays offered by display screens 245 through user interface 219 as facilitated by user interface logic 211. For example, the distance between two sensor(s) 241 plus the drift of each of the two pupils from respective sensor of sensor(s) 241 may provide the IPD being the distance between the two pupils. In one embodiment, the measured IPD may also be used by an application, such as a software application running at or hosted by computing device 100, for image adjustment and/or correction.

It is contemplated that distance between pupils varies from human to human and thus any adjustment based on an accurately measured IPD is likely to provide the high-quality stereo 3D view of images in displays. Further, as previously mentioned, various virtual reality HMDs, such as computing device 100, are capable of providing multiple displays or merely a single display using one or more display screen(s) 245 through user interface 219 as facilitated by user interface logic 211. For example, if there is a single display, then two lenses 243 of computing device 100 may be movable so that any distance between two lenses 243 is adjusted to compensate for or aligned with the IPD of the user of computing device 100. Similarly, for example, if there are two displays, then two lenses 243 and/or two displays offered by display screens 245 may be movable so that any distance between two lenses 243 and/or two displays may be adjusted to compensate for or aligned with the IPD of the user of computing device 100. In other words, embodiments provide for a novel technique for adjusting lenses 243 and/or displays offered by display devices 245 to directly align with the pupils of the user for clarity and comfort to facilitate the optimum virtual reality experience for the user.

Referring back to adjustment mechanism 110, each time a user wears or places his face in front of computing device 100 (e.g., HMD), detection/monitoring logic 201 may be triggered to detect the user's presence within proximity of computing device, such as by detecting the user's eyes in front of lenses 243. For example, in some embodiments, detection/monitoring logic 201 may facilitate one or more lenses 243, one or more optical sensors, such as one or more eye-tracking sensor(s) 241, one or more cameras, etc., of capturing/sensing component(s) 231, to detect and realize one or more pupils of the user's eyes and by that conclude the user's presence within device-usable certain proximity of computing device 100. In one embodiment, detection/monitoring logic 201 may be capable of continuously monitoring the user presence or potential user presence using any number and type of detection sensors of capturing/sensing component(s) 231, including, but not limited to, eye-tracking sensor(s) 241, one or more cameras, etc.

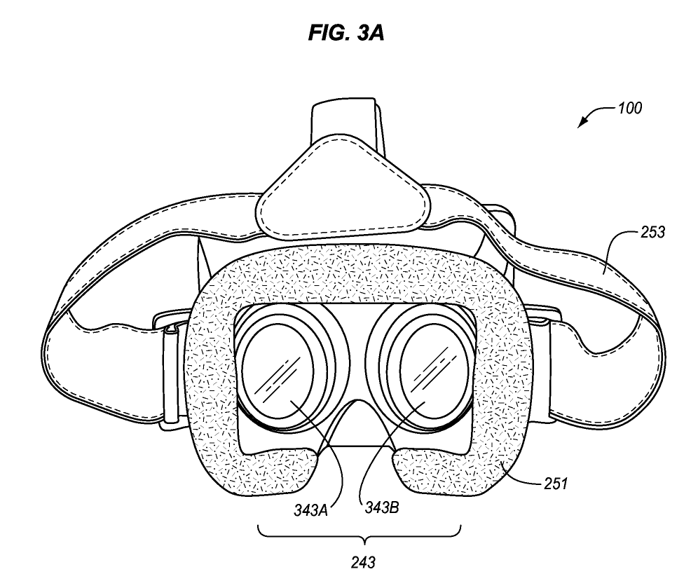

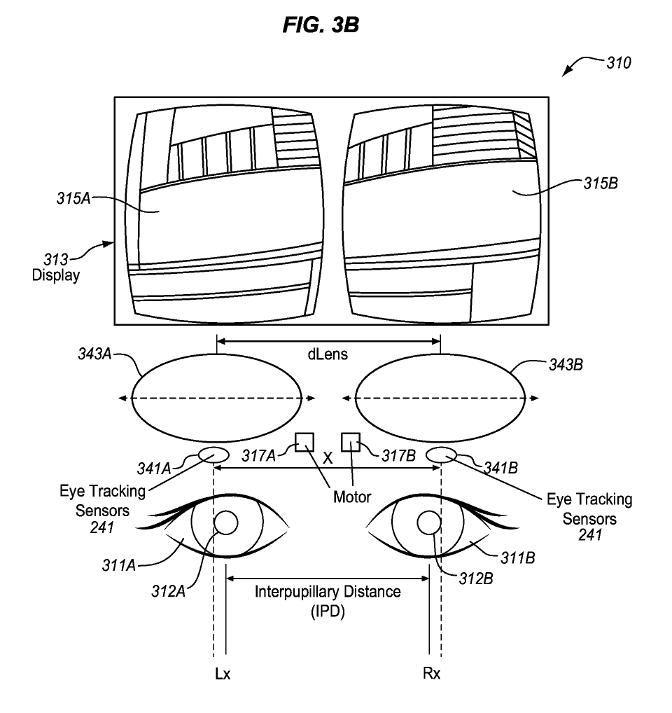

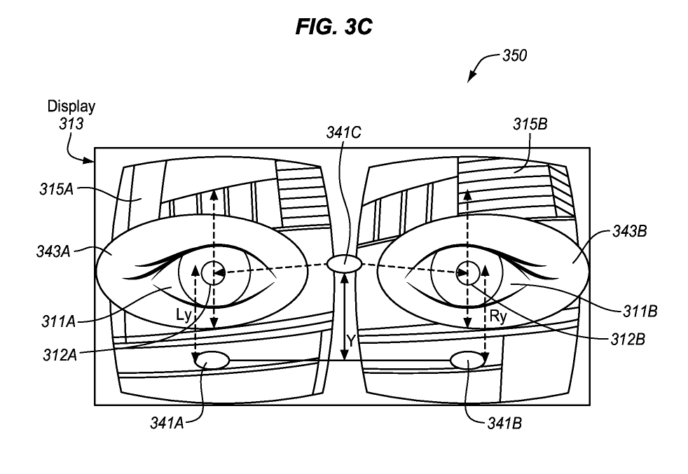

For example, light, such as infrared light, may be reflected from the eyes of the user to be sensed by one or more of capturing/sensing component(s) 231, such as eye-tracking sensor(s) 241, one or more cameras, other specially-purpose optical sensors, etc. In one embodiment, tracking/calibration logic 203 may then be triggered to facilitate, for example, eye-tracking sensor(s) 241 to track the eyes of the user, the pupils of the eyes, any light be reflected off the eyes, and/or the like. For example, video-based eye trackers-based with eye-tracking sensor(s) 241 may be facilitated by tracking/calibration logic 203 to corneal reflection and the centers of the pupils and regard them as features to track over time. Similarly, a more sensitive type of eye tracker, such as dual-Purkinje eye trackers-based eye-tracking sensor(s) 241 may be facilitated by tracking/calibration logic 203 to use reflections from the front of the cornea and the back of lenses 243 and regard them as features to track. In some embodiments, eye-tracking sensor(s) 241 may be placed below each lens 243 such that eye-tracking sensor(s) 241 face the user, as illustrated with reference to FIGS. 3B-3C.

Further, in one embodiment, along with tracking, tracking/calibration logic 203 may be used to perform calibration of the user's eyes, such as by showing the user a two-dimensional (2D) image, such as 2D-duplicated side-by-side (SBS) images, to finely calibrate the pupils of the user's eyes. Once the calibration is performed, in one embodiment, collection logic 205 may be triggered to use changes in reflection relating to the light being reflected from the eyes and/or any calibration information relating to the positioning of the eyes to extract and collect data relating to eye rotation associated with the eyes.

In one embodiment, in using the eye rotation data collected by collection logic 205, measurement/analysis logic 207 may then be used to derive the IPD, such as the distance between the two pupils of the two eyes, and derive the X and Y adjustment parameters. For example, X may represent a horizontal distance between eye-tracking sensor(s) 241 as shown and described with reference to FIG. 3B, while Y being a vertical distance between eye-tracking sensor(s) 241 as shown and described with reference to FIG. 3C.

For example, as shown in FIG. 3B, in terms of horizontal difference, X, any difference or distance between the left sensor of sensor(s) 241 and the left pupil of the left eye may be regarded as Lx as measured by measurement/analysis logic 207, while any difference or distance between the right sensor of sensor(s) 241 and the right pupil of the right eye may be regarded as Rx as measured by measurement/analysis logic 207, and it is the reconciliation of these difference, as analyzed by measurement/analysis logic 207, that may be achieved by adjusting lenses 243 and/or displays at computing device 100 as facilitated by adjustment/execution logic 209. For example, as facilitated by adjustment/execution logic 209, one or more of lenses 243 may be adjusted by moving to the left or the right to compensate for Lx or Rx, respectively, such that both lenses 243 are accurately and directly aligned with the two pupils of the two eyes. For example, one or more lenses 243 may be physically moved or adjusted by one or more motors 217, which may be located within a short proximity of lenses 243. Similarly, as facilitated by adjustment/execution logic 209, one or more of displays as offered by one or more display screens 245 of computing device 100 may be adjusted by moving to the left or the right to compensate for Lx or Rx, respectively, such that both displays are accurately and directly aligned with the two pupils of the two eyes.

It is contemplated that embodiments are not limited to movement of lenses 243 or displays and that in some embodiments a combination of lenses 243 and display may be adjusted to achieve the desired adjustment. Similarly, it is contemplated that the adjustments not limited to any particular direction and that they may be made by horizontal movement, as shown in FIG. 3B, vertical movement, as shown in FIG. 3C, diagonal movement, or any combination therefore. Once adjusted, the user experience of virtual reality viewing may continue with the current adjustment of lenses 243 and/or display until another adjustment is needed, such as when another user accessing and using computing device 100.

Capturing/sensing components 231 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing component(s) 231 may further include one or more of supporting or supplemental devices for capturing and/or sensing of data, such as illuminators (e.g., IR illuminator), light fixtures, generators, sound blockers, etc.

It is further contemplated that in one embodiment, capturing/sensing component(s) 231 may further include any number and type of context sensors (e.g., linear accelerometer) for sensing or detecting any number and type of contexts (e.g., estimating horizon, linear acceleration, etc., relating to a mobile computing device, etc.). For example, capturing/sensing component(s) 231 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, capturing/sensing component(s) 231 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and/or TEE logic. TEE logic may be employed separately or be part of resource requestor and/or an I/O subsystem, etc. Capturing/sensing component(s) 231 may further include voice recognition devices, photo recognition devices, facial and other body recognition components, voice-to-text conversion components, etc.

Similarly, output component(s) 233 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) 233 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any particular number or type of use-case scenarios, architectural placements, or component setups; however, for the sake of brevity and clarity, illustrations and descriptions with respect FIGS. 3B-3C are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer”, and/or the like.

Communication/compatibility logic 213 may be used to facilitate dynamic communication and compatibility between various components, networks, computing devices, etc., such as computing device 100, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and/or the like, may be referenced interchangeably and include, by way of example, software, hardware, and/or any combination of software and hardware, such as firmware. In one example, “logic” may refer to or include a software component that is capable of working with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

Further, any use of a particular brand, word, term, phrase, name, and/or acronym, such as “head-mounted display”, “HMD”, “game display”, “interpupillary distance”, “IPD”, “displays”, “displays screen”, “optical sensor”, “eye-tracking sensor”, “pupil”, “eye”, “adjustment”, “lens”, “automatic”, “dynamic”, “user interface”, “camera”, “sensor”, “microphone”, “display screen”, “speaker”, “recognition”, “authentication”, “privacy”, “user”, “user profile”, “user preference”, “sender”, “receiver”, “personal device”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from adjustment mechanism 110 to facilitate various embodiments including adding, removing, and/or enhancing certain features. For brevity, clarity, and ease of understanding of adjustment mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates computing device 100 of FIG. 2 including a head-mounted display according to one embodiment. As illustrated, in one embodiment, computing device 100 includes a virtual reality HMD having lenses 243, including left lens 343A and right lens 343B, to which the eyes of the user are pointed, cushion or pad 301 to rest the user's head and other parts of the face, strap 303 to wrap around the user's head to hold computing device 100 in place. Further, when worn, the users eyes would not only face lenses 243 but also view any virtual reality display when shown on one or more display screens, such as display screen(s) 245, within computing device 100 as supported by user interface 219 and facilitated by user interface logic 211 of FIG. 2.

It is contemplated and to be noted that computing device 100 is not merely limited to this illustrated HMD and that as previously discussed with reference to FIGS. 1-2, any number and type of viewing systems or devices, such as HMDs, NVGs, binoculars, binocular viewing systems, binocular microscopes, wearable glasses, head-mounted binoculars, gaming displays, military headwear, and/or the like, may be used. Similarly, computing device 100 may include any number and type of other forms of computing devices, such as smartphones, tablet computers, laptops, wearable devices, IoT devices, and/or the like.

FIG. 3B illustrates an architectural placement 310 to allow for horizontal adjustment of lenses 343A, 343B and/or display 313 using adjustment mechanism 110 of FIGS. 1-2 according to one embodiment. As an initial matter, for brevity, many of the details discussed with reference to the previous FIGS. 1-2 may not be discussed or repeated hereafter. Further, it is contemplated and to be noted that embodiments are not limited to any particular number or type of architectural placements, component setups, processes, and/or use-case scenarios, etc., such as architectural placement 310.

As illustrated, in this embodiment, computing device 100 of FIGS. 1-3A includes a set of lenses, such as left lens 343A and right lens 343B, which are the same as or similar to lenses 243 of FIG. 2. Further, as illustrated, left lens 343A and right lens 343B are associated with left eye-tracking sensor 341A and right eye-tracking sensor 341B, respectively, which are the same as or similar to eye-tracking sensors 241 of FIG. 2. As illustrated here and further discussed with reference to FIG. 2, when a user having a set of eyes 311A, 311B comes in close proximity of lenses 343A, 343B, such that the left eye 311A and right eye 311B are set in a position to face left lens 343A and right lens 343B, respectively, then the user may view one or more displays, such as display 313, on a display screen, such as one or more of display screens 245, of FIG. 2.

In the illustrated embodiment, display 313 is a single display that one or more eyes 311A, 311B can see through one or more lenses 343A, 343B, but it is contemplated that embodiments are not limited to single displays or devices offering single displays. Although display 313 is a single display, sub-displays or views 315A, 315B are shown as capturing portions of an overall view, such as an actual or virtual reality view, being seen by the user such that eyes 311A and 311B see views 315A and 315B, respectively.

In the illustrated embodiment, lenses 343A, 343B are capable of being moved on X-axis using, for example, an automatic motorized tool or mechanism, such as motors 317A, 317B, that are attached to or coupled with lenses 343A, 343B, respectively, as facilitated by adjustment/execution logic 209 of FIG. 2. For example, when triggered by adjustment/execution logic 209 of FIG. 2, one or more of motors 317A, 317B may move one or more of lenses 343A, 343B, respectively, to the left or right of the X-axis to compensate for any correspondingly deficiencies, such as Lx and Rx, so that lenses 343A, 343B are directly aligned with pupils 312A, 312B of the user's eyes 311A, 311B, respectively. Examples of motors 317A, 317B may include, without limitations, self-geared micro-motors or stepper motors that are capable of being used with extra gears to create linear and/or other directional movement of lenses 343A, 343B.

In the illustrated embodiment, two motors 317A and 317B are shown as placed below and being associated with and capable of moving their corresponding two lenses 343A and 343B, but it is contemplated that embodiments are not limited to any particular placement or association of motors 317A, 317B. For example, in some embodiments, there may only be a single motor or more than two motors responsible for both lenses 343A, 343B and/or display 313 and similarly, motors 317A, 317B may not necessarily be place as illustrated here, but that they may placed behind, above, on the side, or within any proximity of lenses 343A, 343B and/or display 313, as necessitated or desired, and still be capable of performing their tasks.

In one embodiment, eye-tracking sensors 341A, 341B are placed to track the corresponding pupils 312A, 312B of eyes 311A, 311B, where the distance between eye-tracking sensors 341A, 341B is fixed and referred to as X as obtained by collection logic 205 or computed by measurement/analysis logic 207. Then, for example, using measurement/analysis logic 207 of FIG. 2, the left distance between left eye-tracking sensor 341A and the corresponding left pupil 312A is measured as Lx, while the right distance between right eye-tracking sensor 341A and the corresponding right pupil 312A is measured as Rx. These Lx and Rx values may be regarded as the deficiency between X and the current placement of pupils 312A, 312B. Upon measuring Lx and/or Rx, adjustment/execution logic 209 of FIG. 2 may then be triggered to facilitate one or more of motors 317A, 317B to move one or more of the corresponding lenses 343A, 343B to perform the necessary adjustment to compensate for any deficiencies, such as Lx and/or Rx, so that lenses 343A, 343B are directly aligned with pupils 312A, 312B such that the distance X or dLens is matched to the IPD. It is contemplated that motors 317A and 317B are the same as or similar to motor(s) 217 of FIG. 2.

As aforementioned, embodiments are not limited to merely adjusting lenses, such as lenses 343A, 343B, but that displays, such as display 313, may also be adjusted to achieve the same results. Further, it is to be noted that movements are not merely limited to X-axis and that such adjustments can be performed on Y-axis, Z-axis, etc., as illustrated in FIG. 3C. In the illustrated embodiment, however, given display 313 is a single display, its adjustment may not be necessitated and instead, one or more lenses 343A, 343B may be adjusted to compensate for any deficiencies, such as Lx and/or Rx, with regard to the IPD to directly align lenses 343A, 343B with pupils 312A, 312B, respectively.

FIG. 3C illustrates an architectural placement 350 to allow for vertical adjustment of lenses 343A, 343B and/or display 313 using adjustment mechanism 110 of FIGS. 1-2 according to one embodiment. As an initial matter, for brevity, many of the details discussed with reference to the previous FIGS. 1-2 may not be discussed or repeated hereafter. Further, it is contemplated and to be noted that embodiments are not limited to any particular number or type of architectural placements, component setups, processes, and/or use-case scenarios, etc., such as architectural placement 310.

With repeating some of the details set forth above with respect to FIG. 3B, in the illustrated embodiment, the adjustment is made vertically on Y-axis to achieve the necessary alignment between pupils 312A, 312B of eyes 311A, 311B with lenses 343A, 343B. As with FIG. 3B, there is a single display 313 having views 315A and 315B of an actual or virtual reality view being observed by eyes 311A and 311B, respectively.

In the illustrated embodiment, since the adjustment is vertical, such as on the Y-axis, the IPD deficiencies are also measured by measurement/analysis logic 207 of FIG. 2 on the Y-axis, such Ly for left eye 311A, and Ry for right eye 311B. Further, as illustrated, eye-tracking sensors 241 may include eye-tracking sensors 341A and 341B along with an additional eye-tracking sensor 341C that is placed on the Y-axis about Y distance above eye-tracking sensors 341A and 341B, but in a centralized manner nearly the same distance from both eye-tracking sensors 341A and 341B on the X-axis. In one embodiment, one or more of lenses 343A, 343B are adjusted vertically on the Y-axis using one or more of motors 317A, 317B as facilitated by adjustment/execution logic 209.

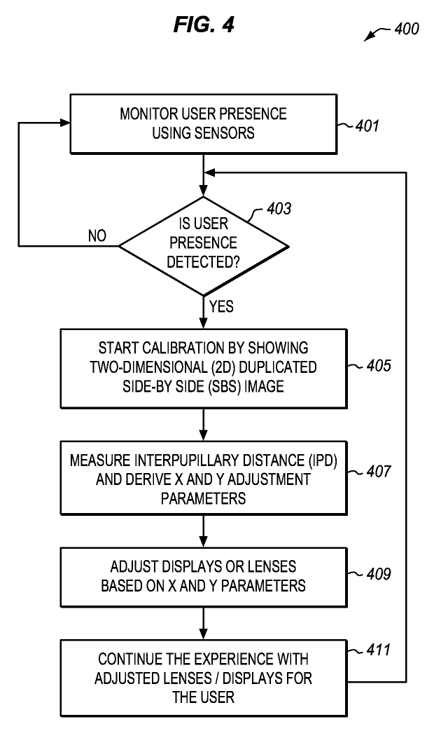

FIG. 4 illustrates a method 400 for facilitating dynamic and automatic adjustment of lenses and/or displays of a computing device based on IPDs associated with one or more users according to one embodiment. Method 400 may be performed by processing logic that may comprise hardware (e.g., circuitry, dedicated logic, programmable logic, etc.), software (such as instructions run on a processing device), or a combination thereof, as facilitated by adjustment mechanism 110 of FIG. 1. The processes of method 400 are illustrated in linear sequences for brevity and clarity in presentation; however, it is contemplated that any number of them can be performed in parallel, asynchronously, or in different orders. For brevity, many of the details discussed with reference to the previous FIGS. 1-3C may not be discussed or repeated hereafter.

Method 400 begins at block 401 with monitoring of user presence within proximity of a computing device (e.g., HMD), such as whether a user of the computing device is attempting to use the computing device. In one embodiment, the computing device, such as a gaming display, a binocular system, etc., may include one or more lenses and offer one or more displays through one or more display screen as offered by a user interface. At block 403, a determination is made as to whether the user has been detected, such as whether the user is wearing the computing device on the head and looking through lenses of the computing device. If not, method 400 continues with further monitoring at block 401. If yes, method 400 proceeds to block 405 with calibration of the users eyes in relation to the lenses of the computing device by showing, for example, 2D duplicated side-by-side images.

At block 407, IPD relating to the user's eyes is measured along with deriving adjustment values for X and/or Y parameters. For example, X may be horizontal distance between to two eye-tracking sensors associated with the two lenses, where the IPD indicates deficiency on the X-axis between the distance X and the distance between the two pupils of the two eyes of the user. Similarly, Y may be vertical distance between two or more eye-tracking sensors associated with the two lenses, where the IPD indicates deficiency on the Y-axis between the distance Y and the distance between the two pupils of the two eyes of the user with respect to the two lenses. At block 409, one or more of the lenses and/or one or more of the displays are automatically and dynamically adjusted, horizontally on the X-axis and/or vertically on the Y-axis, based on the X and/or Y parameters and the corresponding IPD. In one embodiment, horizontal and/or vertical adjustments are achieved by moving, for example, one or more lenses using one or more motors associated with the one or more lenses. In one embodiment, any automatic and dynamic adjustment to one or more of the lenses and/or displays may result in direct alignment of the lenses with the pupils of the user's eyes to offer an optimum viewing experience for the user.

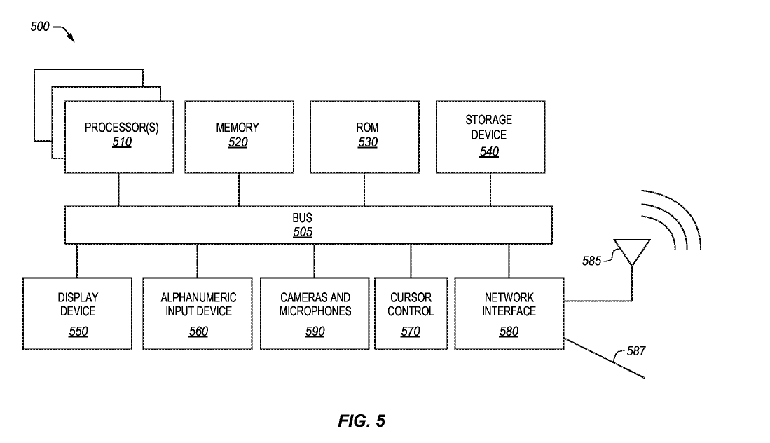

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

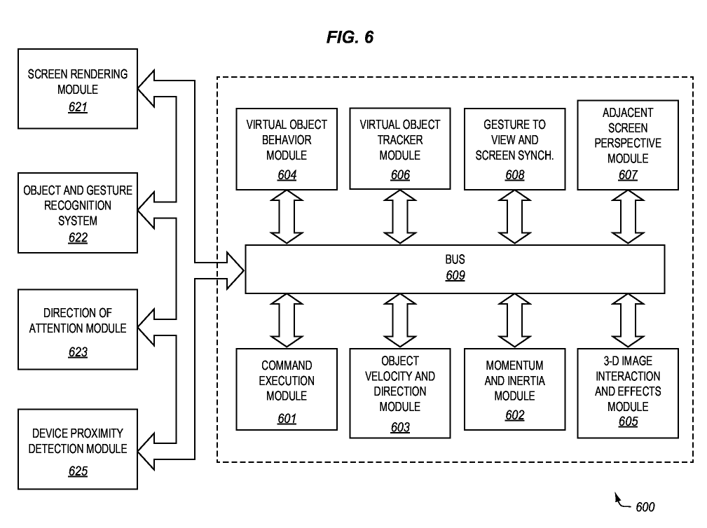

FIG. 6 illustrates an embodiment of a computing environment 600 capable of supporting the operations discussed above. The modules and systems can be implemented in a variety of different hardware architectures and form factors including that shown in FIG. 5.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 601, 602, 603, 604, 605. 606, 607, and 608 are connected via an interconnect or a bus, such as bus 609.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate automatic view adjustment for computing devices based on interpupillary distance associated with users, the apparatus comprising: detection/monitoring logic to facilitate sensors to detect a user within proximity of the apparatus such that eyes of the user face lenses of the apparatus; measurement/analysis logic to measure a first distance between a first sensor and a second sensor of the sensors, wherein the measurement/analysis logic is further to measure a second distance between a first pupil of a first eye of the eyes and a second pupil of a second eye of the eyes of the user; and adjustment/execution logic to adjust a first lens or a second lens of the lenses to match the second distance with the first distance.

Example 2 includes the subject matter of Example 1, wherein the second distance matching the first distance facilitates the first pupil and the second pupil to directly align with the first lens and the second lens, respectively.

Example 3 includes the subject matter of Example 1, wherein the second distance comprises interpupillary distance (IPD), wherein the first distance represents a horizontal distance between the first and second sensors.

Example 4 includes the subject matter of Example 1, further comprising tracking/calibration logic to: calibrate the eyes with respect to the lenses and/or displays by placing a two-dimensional (2D) image side-by-side for viewing by the eyes; and facilitate the sensors to continuously track light reflections emitting from the eyes, wherein the sensors comprise one or more optical sensors including one or more eye-tracking sensors.

Example 5 includes the subject matter of Example 1, further comprising collection logic to collect data relating to eye rotations associated with the eyes, wherein the eye rotations are extracted based on changes in the light reflections.

Example 6 includes the subject matter of Example 1, wherein the adjustment/execution logic is further to adjust one or more displays to match the second distance with the first distance, wherein the one or more displays are provided by a user interface.

Example 7 includes the subject matter of Example 1, wherein the measurement/analysis logic is further to measure a third distance represents a vertical distance between a third sensor and the first and second sensors, and wherein the adjustment/execution logic is further to adjust the first lens or the second lens to directly align the first and second pupils with the first and second lenses, respectively.

Example 8 includes the subject matter of Example 7, wherein the adjustment/execution logic to adjust one or more displays to directly align the first and second pupils with the first and second lenses, respectively.

Example 9 includes the subject matter of Example 1, wherein the apparatus comprises a viewing system including a head-mounted display (HMD) system having one or more of night vision goggles (NVG), binoculars, binocular viewing systems, binocular microscopes, wearable glasses, head-mounted binoculars, gaming displays, and military headwear.

Some embodiments pertain to Example 10 that includes a method for facilitating automatic view adjustment for computing devices based on interpupillary distance associated with users, the method comprising: facilitating sensors to detect a user within proximity of the apparatus such that eyes of the user face lenses of a computing device; measuring a first distance between a first sensor and a second sensor of the sensors; measuring a second distance between a first pupil of a first eye of the eyes and a second pupil of a second eye of the eyes of the user; and adjusting a first lens or a second lens of the lenses to match the second distance with the first distance.

Example 11 includes the subject matter of Example 10, wherein the second distance matching the first distance facilitates the first pupil and the second pupil to directly align with the first lens and the second lens, respectively.

Example 12 includes the subject matter of Example 10, wherein the second distance comprises interpupillary distance (IPD), wherein the first distance represents a horizontal distance between the first and second sensors.

Example 13 includes the subject matter of Example 10, further comprising: calibrating the eyes with respect to the lenses and/or displays by placing a two-dimensional (2D) image side-by-side for viewing by the eyes; and facilitating the sensors to continuously track light reflections emitting from the eyes, wherein the sensors comprise one or more optical sensors including one or more eye-tracking sensors.

Example 14 includes the subject matter of Example 10, further comprising collecting data relating to eye rotations associated with the eyes, wherein the eye rotations are extracted based on changes in the light reflections.

Example 15 includes the subject matter of Example 10, further comprising adjusting one or more displays to match the second distance with the first distance, wherein the one or more displays are provided by a user interface.

Example 16 includes the subject matter of Example 10, further comprising measuring a third distance represents a vertical distance between a third sensor and the first and second sensors, and wherein the adjustment/execution logic is further to adjust the first lens or the second lens to directly align the first and second pupils with the first and second lenses, respectively.

Example 17 includes the subject matter of Example 16, further comprising adjusting one or more displays to directly align the first and second pupils with the first and second lenses, respectively.

Example 18 includes the subject matter of Example 10, wherein the computing device comprises a viewing system including a head-mounted display (HMD) system having one or more of night vision goggles (NVG), binoculars, binocular viewing systems, binocular microscopes, wearable glasses, head-mounted binoculars, gaming displays, and military headwear.

Some embodiments pertain to Example 19 includes a system comprising a storage device having instructions, and a processor to execute the instructions to facilitate a mechanism to: facilitate sensors to detect a user within proximity of the apparatus such that eyes of the user face lenses of a computing device; measure a first distance between a first sensor and a second sensor of the sensors; measure a second distance between a first pupil of a first eye of the eyes and a second pupil of a second eye of the eyes of the user; and adjust a first lens or a second lens of the lenses to match the second distance with the first distance.

Example 20 includes the subject matter of Example 19, wherein the second distance matching the first distance facilitates the first pupil and the second pupil to directly align with the first lens and the second lens, respectively.

Example 21 includes the subject matter of Example 19, wherein the second distance comprises interpupillary distance (IPD), wherein the first distance represents a horizontal distance between the first and second sensors.

Example 22 includes the subject matter of Example 19, wherein the mechanism is further to: calibrate the eyes with respect to the lenses and/or displays by placing a two-dimensional (2D) image side-by-side for viewing by the eyes; and facilitate the sensors to continuously track light reflections emitting from the eyes, wherein the sensors comprise one or more optical sensors including one or more eye-tracking sensors.

Example 23 includes the subject matter of Example 19, wherein the mechanism is further to collect data relating to eye rotations associated with the eyes, wherein the eye rotations are extracted based on changes in the light reflections.

Example 24 includes the subject matter of Example 19, wherein the mechanism is further to adjust one or more displays to match the second distance with the first distance, wherein the one or more displays are provided by a user interface.

Example 25 includes the subject matter of Example 19, wherein the mechanism is further to measure a third distance represents a vertical distance between a third sensor and the first and second sensors, and wherein the adjustment/execution logic is further to adjust the first lens or the second lens to directly align the first and second pupils with the first and second lenses, respectively.

Example 26 includes the subject matter of Example 25, wherein the mechanism is further to adjust one or more displays to directly align the first and second pupils with the first and second lenses, respectively.

Example 27 includes the subject matter of Example 19, wherein the computing device comprises a viewing system including a head-mounted display (HMD) system having one or more of night vision goggles (NVG), binoculars, binocular viewing systems, binocular microscopes, wearable glasses, head-mounted binoculars, gaming displays, and military headwear.

Some embodiments pertain to Example 28 includes an apparatus comprising: means for facilitating sensors to detect a user within proximity of the apparatus such that eyes of the user face lenses of a computing device; means for measuring a first distance between a first sensor and a second sensor of the sensors; means for measuring a second distance between a first pupil of a first eye of the eyes and a second pupil of a second eye of the eyes of the user; and means for adjusting a first lens or a second lens of the lenses to match the second distance with the first distance.

Example 29 includes the subject matter of Example 28, wherein the second distance matching the first distance facilitates the first pupil and the second pupil to directly align with the first lens and the second lens, respectively.

Example 30 includes the subject matter of Example 28, wherein the second distance comprises interpupillary distance (IPD), wherein the first distance represents a horizontal distance between the first and second sensors.

Example 31 includes the subject matter of Example 28, further comprising means for calibrating the eyes with respect to the lenses and/or displays by placing a two-dimensional (2D) image side-by-side for viewing by the eyes; and means for facilitating the sensors to continuously track light reflections emitting from the eyes, wherein the sensors comprise one or more optical sensors including one or more eye-tracking sensors.

Example 32 includes the subject matter of Example 28, further comprising means for collecting data relating to eye rotations associated with the eyes, wherein the eye rotations are extracted based on changes in the light reflections.

Example 33 includes the subject matter of Example 28, further comprising means for adjusting one or more displays to match the second distance with the first distance, wherein the one or more displays are provided by a user interface.

Example 34 includes the subject matter of Example 28, further comprising means for measuring a third distance represents a vertical distance between a third sensor and the first and second sensors, and wherein the adjustment/execution logic is further to adjust the first lens or the second lens to directly align the first and second pupils with the first and second lenses, respectively.

Example 35 includes the subject matter of Example 34, further comprising means for adjusting one or more displays to directly align the first and second pupils with the first and second lenses, respectively.

Example 36 includes the subject matter of Example 28, wherein the computing device comprises a viewing system including a head-mounted display (HMD) system having one or more of night vision goggles (NVG), binoculars, binocular viewing systems, binocular microscopes, wearable glasses, head-mounted binoculars, gaming displays, and military headwear.

Example 37 includes at least one non-transitory machine-readable medium comprising a plurality of instructions, when executed on a computing device, to implement or perform a method as claimed in any of claims or examples 10-18.

Example 38 includes at least one machine-readable medium comprising a plurality of instructions, when executed on a computing device, to implement or perform a method as claimed in any of claims or examples 10-18.

Example 39 includes a system comprising a mechanism to implement or perform a method as claimed in any of claims or examples 10-18.

Example 40 includes an apparatus comprising means for performing a method as claimed in any of claims or examples 10-18.

Example 41 includes a computing device arranged to implement or perform a method as claimed in any of claims or examples 10-18.

Example 42 includes a communications device arranged to implement or perform a method as claimed in any of claims or examples 10-18.

Example 43 includes at least one machine-readable medium comprising a plurality of instructions, when executed on a computing device, to implement or perform a method or realize an apparatus as claimed in any preceding claims or examples.

Example 44 includes at least one non-transitory machine-readable medium comprising a plurality of instructions, when executed on a computing device, to implement or perform a method or realize an apparatus as claimed in any preceding claims or examples.

Example 45 includes a system comprising a mechanism to implement or perform a method or realize an apparatus as claimed in any preceding claims or examples.

Example 46 includes an apparatus comprising means to perform a method as claimed in any preceding claims or examples.

Example 47 includes a computing device arranged to implement or perform a method or realize an apparatus as claimed in any preceding claims or examples.

Example 48 includes a communications device arranged to implement or perform a method or realize an apparatus as claimed in any preceding claims or examples.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection/monitoring logic to facilitate sensors to detect a user within proximity of the apparatus such that eyes of the user face lenses of the apparatus;
measurement/analysis logic to measure a first distance between a first sensor and a second sensor of the sensors, wherein the measurement/analysis logic is further to measure a second distance between a first pupil of a first eye of the eyes and a second pupil of a second eye of the eyes of the user; and
adjustment/execution logic to adjust a first lens or a second lens of the lenses to match the second distance with the first distance.

2. The apparatus of claim 1, wherein the second distance matching the first distance facilitates the first pupil and the second pupil to directly align with the first lens and the second lens, respectively.

3. The apparatus of claim 1, wherein the second distance comprises interpupillary distance (IPD), wherein the first distance represents a horizontal distance between the first and second sensors.

4. The apparatus of claim 1, further comprising tracking/calibration logic to:
calibrate the eyes with respect to the lenses and/or displays by placing a two-dimensional (2D) image side-by-side for viewing by the eyes; and
facilitate the sensors to continuously track light reflections emitting from the eyes, wherein the sensors comprise one or more optical sensors including one or more eye-tracking sensors.

5. The apparatus of claim 1, further comprising collection logic to collect data relating to eye rotations associated with the eyes, wherein the eye rotations are extracted based on changes in the light reflections.

6. The apparatus of claim 1, wherein the adjustment/execution logic is further to adjust one or more displays to match the second distance with the first distance, wherein the one or more displays are provided by a user interface.

7. The apparatus of claim 1, wherein the measurement/analysis logic is further to measure a third distance represents a vertical distance between a third sensor and the first and second sensors, and wherein the adjustment/execution logic is further to adjust the first lens or the second lens to directly align the first and second pupils with the first and second lenses, respectively.

8. The apparatus of claim 7, wherein the adjustment/execution logic to adjust one or more displays to directly align the first and second pupils with the first and second lenses, respectively.

9. The apparatus of claim 1, wherein the apparatus comprises a viewing system including a head-mounted display (HMD) system having one or more of night vision goggles (NVG), binoculars, binocular viewing systems, binocular microscopes, wearable glasses, head-mounted binoculars, gaming displays, and military headwear.

10. A method comprising:
facilitating sensors to detect a user within proximity of the apparatus such that eyes of the user face lenses of a computing device;
measuring a first distance between a first sensor and a second sensor of the sensors;
measuring a second distance between a first pupil of a first eye of the eyes and a second pupil of a second eye of the eyes of the user; and
adjusting a first lens or a second lens of the lenses to match the second distance with the first distance.

11. The method of claim 10, wherein the second distance matching the first distance facilitates the first pupil and the second pupil to directly align with the first lens and the second lens, respectively.

12. The method of claim 10, wherein the second distance comprises interpupillary distance (IPD), wherein the first distance represents a horizontal distance between the first and second sensors.

13. The method of claim 10, further comprising:
calibrating the eyes with respect to the lenses and/or displays by placing a two-dimensional (2D) image side-by-side for viewing by the eyes; and
facilitating the sensors to continuously track light reflections emitting from the eyes, wherein the sensors comprise one or more optical sensors including one or more eye-tracking sensors.

14. The method of claim 10, further comprising collecting data relating to eye rotations associated with the eyes, wherein the eye rotations are extracted based on changes in the light reflections.

15. The method of claim 10, further comprising adjusting one or more displays to match the second distance with the first distance, wherein the one or more displays are provided by a user interface.

16. The method of claim 10, further comprising measuring a third distance represents a vertical distance between a third sensor and the first and second sensors, and wherein the adjustment/execution logic is further to adjust the first lens or the second lens to directly align the first and second pupils with the first and second lenses, respectively.

17. The method of claim 16, further comprising adjusting one or more displays to directly align the first and second pupils with the first and second lenses, respectively.

18. The method of claim 10, wherein the computing device comprises a viewing system including a head-mounted display (HMD) system having one or more of night vision goggles (NVG), binoculars, binocular viewing systems, binocular microscopes, wearable glasses, head-mounted binoculars, gaming displays, and military headwear.

19. At least one machine-readable medium comprising instructions which, when executed by a computing device, cause the computing device to perform operations comprising:
facilitating sensors to detect a user within proximity of the apparatus such that eyes of the user face lenses of a computing device;
measuring a first distance between a first sensor and a second sensor of the sensors;
measuring a second distance between a first pupil of a first eye of the eyes and a second pupil of a second eye of the eyes of the user; and
adjusting a first lens or a second lens of the lenses to match the second distance with the first distance.

20. The machine-readable medium of claim 19, wherein the second distance matching the first distance facilitates the first pupil and the second pupil to directly align with the first lens and the second lens, respectively.

21. The machine-readable medium of claim 19, wherein the second distance comprises interpupillary distance (IPD), wherein the first distance represents a horizontal distance between the first and second sensors.

22. The machine-readable medium of claim 19, wherein the operations further comprise:
calibrating the eyes with respect to the lenses and/or displays by placing a two-dimensional (2D) image side-by-side for viewing by the eyes; and
facilitating the sensors to continuously track light reflections emitting from the eyes, wherein the sensors comprise one or more optical sensors including one or more eye-tracking sensors.

23. The machine-readable medium of claim 19, wherein the operations further comprise:
collecting data relating to eye rotations associated with the eyes, wherein the eye rotations are extracted based on changes in the light reflections; and
adjusting one or more displays to match the second distance with the first distance, wherein the one or more displays are provided by a user interface.

24. The machine-readable medium of claim 19, wherein the operations further comprise:
measuring a third distance represents a vertical distance between a third sensor and the first and second sensors, and wherein the adjustment/execution logic is further to adjust the first lens or the second lens to directly align the first and second pupils with the first and second lenses, respectively; and
adjusting one or more displays to directly align the first and second pupils with the first and second lenses, respectively.

25. The machine-readable medium of claim 19, wherein the computing device comprises a viewing system including a head-mounted display (HMD) system having one or more of night vision goggles (NVG), binoculars, binocular viewing systems, binocular microscopes, wearable glasses, head-mounted binoculars, gaming displays, and military headwear.
